(19) United States
(12) Patent Application Publication
(10) Pub. No.: US 2013/0281295 A1
(43) Pub. Date: Oct. 24, 2013

(54) METHOD FOR INCREASING LEGUME PRODUCTIVITY BY CULTIVATING A PLANT WITH AN ASSOCIATED RHIZOBIUM OVEREXPRESSING A FLAVOHEMOGLOBIN PROTEIN

(71) Applicants: Claude Bruand, Castanet-Tolosan (FR); Yvan Cam, Rebigue (FR); Eliane Meilhoc, Castanet-Tolosan (FR)

(72) Inventors: Claude Bruand, Castanet-Tolosan (FR); Yvan Cam, Rebigue (FR); Eliane Meilhoc, Castanet-Tolosan (FR)

(21) Appl. No.: 13/997,115

(22) PCT Filed: Dec. 22, 2011
(86) PCT No.: PCT/EP11/73751

§ 371 Date: Jun. 21, 2013

(51) Int. Cl. A01N 63/02

(52) U.S. Cl. CPC A01N 63/02
USPC 504/117; 800/298; 800/312

(57) ABSTRACT

The invention is related to a symbiotic system comprising a plant of the Leguminosae family, and a bacterium of the rhizobium family, wherein in said bacterium a gene coding for a flavohemoglobin protein is over expressed. The present invention is also related to a method for delaying the senescence of symbiotic nodules, comprising inoculating a plant of the Leguminosae family with a bacterium of the rhizobium family, wherein said rhizobium overexpresses a gene coding for a flavohemoglobin protein. A method for cultivating a plant of the Leguminosae family is also disclosed.

The present invention is related to a new symbiotic system comprising a plant of the Leguminosae family, inoculated with a bacterium of the rhizobium family to allow the plant to develop nodules, wherein said nodules have an increased life time, their senescence being delayed.

Under nitrogen-limiting conditions, capable plants (usually legumes) form a symbiotic relationship with host-specific strains of bacteria known as “rhizobia” (or bacteria of the rhizobium family). New organs called “nodules” form on the roots of plants that associate with rhizobia. Within legume nodules, rhizobia convert nitrogen gas from the atmosphere into ammonia, which is then assimilated into amino acids, nucleotides, and other cellular constituents such as vitamins, flavones, and hormones for the benefit of the plant. Inoculation of legume crops with nitrogen-fixing symbiotic bacteria is a common agricultural practice to limit the use of nitrogen inputs.

Symbiotic nodules have a limited functional life. Nodule senescence is characterized by structural, molecular, biochemical and physiological events taking place in a process leading to the loss of the nitrogen-fixing activity, and culminating in cell death of symbiotic tissues. During nodule senescence, the nitrogenase activity dramatically decreases, and several ultra-structural alterations in tissues and cells are observed (Puppo et al. 2005).

In addition to the natural, developmental nodule senescence process, a premature nodule senescence can be triggered upon exposure of the plant to stressful conditions such as darkness, drought or the presence of nitrate.

To improve the nitrogen fixation of plants, one solution is to improve the life-time of these specific organs involved in nitrogen fixation. Delaying nodule senescence would lead to an increased nitrogen fixation in the cultivated plant, and therefore to a better legume productivity.

### PRIOR ART

Nitric oxide (nitrogen monoxide, NO), is a natural free radical used in signal transduction in both plants and animals. Nitric oxide plays a key role in intracellular signalling in biological systems, but it is also potentially toxic due to its reaction with a variety of cellular targets. Different mechanisms are used by bacteria to counteract NO stress. One of the most frequent is the degradation of NO by a flavohemoglobin, an enzyme specialized in NO detoxification, with nitrate (NO₃⁻) as end product under aerobic conditions.

### Flavohemoglobins and Identification of the hmp Gene.

Flavohemoglobins are classified EC 1.14.12.17 and are also called ‘nitric oxide dioxygenase’. Flavohemoglobin proteins have a high sequence homology and structural similarity in their globin domain with hemoglobins, but the flavohemoglobin proteins contain an additional reductase domain at their C-terminus. Their roles are also different: hemoglobins bind O₂ and NO to their heme and transport and deliver gases to tissues, while flavohemoglobins detoxify NO in an aerobic process called “NO dioxygenase reaction” to protect the microorganisms from noxious nitrogen compounds.

The response to NO of Sinorhizobium meliloti, the microsymbiont of alfalfa, was studied using a transcriptomic approach. Approximately 100 bacterial genes whose expression is upregulated in presence of NO were identified, comprising the hmp gene, which encodes a flavohemoglobin. A hmp− mutant displays a higher sensitivity toward NO in culture, and leads to a reduced nitrogen fixation efficiency in the inoculated plants. On the contrary, a mutant overexpressing the flavohemoglobin encoding gene hmp is highly resistant to NO. These results indicate that Hmp plays a role in the bacterial resistance to NO, and that NO metabolism would play a role in symbiotic interaction between S. meliloti and alfalfa (Meilhoc et al. 2010).

### Effects of Heterologous Hemoglobins Overexpression.

The effects of an overexpression of a heterologous hemoglobin in Rhizobium etli have been reported: in the microorganism, it results in an increased respiratory activity, chemical energy content, and expression of the nitrogen-fixation gene nifHc. Bean plants inoculated with the engineered strains exhibit a higher nitrogenase activity and a higher nitrogen content than bean plants inoculated with the R. etli wild type. It appears that the level of symbiotic nitrogen fixation is higher when the R. etli strains overexpress an heterologous hemoglobin (Ramirez et al., 1999).

In Arabidopsis thaliana, the overexpression of a bacterial flavohemoglobin induces a decrease of NO level in the plant, and results in the senescence of the leaves (Mishina et al., 2007). Authors propose that NO acts as a negative regulator of leaf senescence.

### Effects on Root Nodule Senescence of the Overexpression of Heterologous Proteins.

The effects of an overexpression of a heterologous flavodoxin in bacteria (S. meliloti) associated with alfalfa plants was also studied. Flavodoxin (EC 1.19.6.1) is a protein involved in the response to oxidative stress in microorganisms. In symbiotic nodules of plants associated with flavodoxin-expressing S. meliloti, a significant delay in nodule senescence was observed (Redondo et al., 2009). This effect was unsurprising, since senescence is associated with the presence of reactives oxygen species (ROS), such as superoxide ions and peroxides, and that flavodoxin is an enzyme known to be involved in ROS detoxification. Flavohemoglobin is highly different from flavodoxin, both in terms of structure and activities, as reviewed in Gardner et al., 2005, and Sancho et al., 2006.

### GENERAL DESCRIPTION OF THE INVENTION

Surprisingly, the inventors have shown that nitric oxide (NO) is involved in the senescence of symbiotic nodules. Overexpression of a flavohemoglobin in the rhizobium belonging to the symbiotic system, this enzyme having a NO detoxifying activity in bacteria, allows to decrease NO presence and to delay the senescence of the symbiotic nodule.

A new symbiotic system is here presented, comprising:
a plant of the Leguminosae family, and
a bacterium of the rhizobium family,
   wherein in said bacterium a gene coding for a flavohemoglobin protein is overexpressed.

This new symbiotic system presents nodules with an increased life-time, the process of senescence of symbiotic nodules being delayed. The use of said symbiotic system in agriculture allows a better yield of culture, since Leguminosae plants inoculated with a rhizobium overexpressing a flavohemoglobin protein fix nitrogen during an extended period of time. Other advantages of such symbiotic system, such as increased nitrogen fixation and increased biomass, will be discussed lately.

Advantageously, the gene coding for a flavohemoglobin protein is endogenous, and is overexpressed without any genetic manipulation. In another advantageous embodiment, neither the plant nor the bacterium of the symbiotic system has been genetically modified. The invention is also related to a new method for delaying the senescence of symbiotic nodules, comprising inoculating a plant of the Leguminosae family with a bacterium of the rhizobium family, wherein said rhizobium overexpresses a gene coding for a flavohemoglobin protein, that is involved in nitrogen monoxide (NO) detoxification.

The invention is also related to a new method for cultivating a plant of the Leguminosae family, wherein the plant is inoculated with a bacterium of the rhizobium family overexpressing a flavohemoglobin, allowing a better legume productivity. Advantageously, this culture method allows a better nitrogen fixation, and an increased of the biomass of the plant inoculated with the rhizobium overexpressing a flavohemoglobin.

### DETAILED DESCRIPTION OF THE INVENTION

The invention relates to a new symbiotic system comprising:
a plant of the Leguminosae family, and
a bacterium of the rhizobium family,
   wherein in said bacterium a gene coding for a flavohemoglobin protein is overexpressed. Leguminosae or Fabaceae is a large and economically important family of flowering plants, which is commonly known as the legume family, pea family, bean family or pulse family. The species of this family are found throughout the world, growing in many different environments and climates. A number are important agricultural plants, including: Glycine max (soybean), Phaseolus (beans), Pisum sativum (pea), Cicer arietinum (chickpeas), Medicago sativa (alfalfa), Arachis hypogaea (peanut), Ceratonia siliqua (carob), and Glycyrrhiza glabra (licorice).

The term rhizobium designates a group of Gram-negative soil bacteria that fix nitrogen. Rhizobium forms an endosymbiotic nitrogen fixing association with roots of legumes and of the non-legume Parasponia. The bacteria colonize plant cells within root nodules; here the bacteria convert atmospheric nitrogen to ammonia and then provide organic nitrogenous compounds such as glutamine or ureides to the plant. The plant provides the bacteria with organic compounds made by photosynthesis.

The terms “encoding” or “coding for” refer to the process by which a polynucleotide, through the mechanisms of transcription and translation, produces an amino-acid sequence. This process is allowed by the genetic code, which is the relation between the sequence of bases in DNA and the sequence of amino-acids in proteins. One major feature of the genetic code is to be degenerate, meaning that one amino-acid can be coded by more than one triplet of bases (one “codon”). The direct consequence is that the same amino-acid sequence can be encoded by different polynucleotides. It is well known from the man skilled in the art that the use of codons can vary according to the organisms. Among the codons coding for the same amino-acid, some can be used preferentially by a given microorganism. It can thus be of interest to design a polynucleotide adapted to the codon usage of a particular microorganism in order to optimize the expression of the corresponding protein in this organism.

The term “flavohemoglobin protein” refers to a protein classified EC 1.14.12.17, having a NO detoxifying activity in bacteria. The terms “increased expression of the gene” “enhanced expression of the gene” or “overexpression of the gene” are used interchangeably in the text and have similar meaning. To increase the expression of a gene, the man skilled in the art knows different techniques: increasing the copy-number of the gene in the cells, using a promoter inducing a high level of expression of the gene, attenuating the activity and/or the expression of a direct or indirect transcription repressor of the gene. The “increased expression” is measured in comparison with the normal level of expression of the gene, and is preferentially at least twice the normal level (100% of increase).

The gene is encoded or not by the bacterial genome. When the gene is located on the genome, several copies of the gene can be introduced on the genome by methods of recombination known to the expert in the field (including gene replacement). When the gene is located outside the genome, the gene is carried by different types of plasmids that differ with respect to their origin of replication and thus their copy number in the cell.

In a specific aspect of the invention, the gene encoding the flavohemoglobin protein is endogenous, meaning that it is originated from the rhizobium. In particular, a naturally-occurring rhizobium is selected and isolated, the selection being based on its capacity to express a high level of at least one flavohemoglobin. Said rhizobium is said “overexpressing a gene coding for a flavohemoglobin”. Said rhizobium is not genetically transformed, but is selected for its higher expression of a gene coding for a flavohemoglobin, compared to a usual level of expression in a rhizobium.In a first aspect of the invention, the gene is located on the rhizobium genome.

In a second aspect of the invention, the gene, endogenous or heterologous, is located on a plasmid.

The general term ‘plasmid’ or ‘vector’ designates a DNA molecule that is separate from, and can replicate independently of, the chromosomal DNA. Plasmids are double stranded DNA molecules and are usually circular. They occur naturally in bacteria, and are widely used in genetic engineering since they can express particular genes. The man skilled in the art knows many available plasmids for such uses. Briefly, the gene of interest (here encoding a flavohemoglobin) is inserted into a multiple cloning site (or polylinker) of the plasmid, under the control of a promoter allowing the expression of said gene of interest. Next, the plasmid is introduced into bacteria either by transformation or conjugation. Transformation is a technique well known by the man skilled in the art. Conjugation is the transfer of genetic material between two bacterial cells. The plasmid is mobilizable, which means that it carries only the transfer origin, the transfer functions being encoded either by another plasmid or by the donor strain (so-called “helper” plasmid or strain).

Plasmids can be based, for example, on the RK2 replicon (like the pFAJ1700 series, Dombrecht et al. 2001) or the pBBR1 replicon (like the pBBR1MCS series, Kovach et al. 1995).

In a specific embodiment of the invention, the gene is expressed using promoters with different strength. These promoters are homologous or heterologous.

According to a specific embodiment of the invention, the gene is under the control of a constitutively active promoter. The activity of said promoter is constant and independent of conditions, i.e. said promoter is functional in all types of bacterium, and/or in all types of culture conditions.

According to another aspect of the invention, the promoter is active only in specific zones of the nodule or at specific stages of the symbiosis. The term “active in specific zones or stages” means that a gene expressed under the control of the promoter is predominantly expressed in said zones or stages with no or little expression in other zones or stages. Zone-specific and stage-specific promoters are known to those of ordinary skill in the art. Additional promoters can be identified and characterized using mRNA libraries and/or expression profiling techniques. For example, S. meliloti promoters active in specific zones of alfalfa nodules include RpoE2-dependent promoters (zone II and interzone II-III), FixK-dependent promoters (interzone II-III and zone III), NifA-dependent promoters (zone III).

In a particular embodiment of the invention, the promoter is a natural or a selected variant of the native promoter of the flavohemoglobine encoding gene.

In a specific embodiment, the promoter is inducible. The term “inducible promoter” denotes a promoter whose activity can be increased upon an external stimulus. Use of inducible promoters in biotechnological processes is well known to the expert in the field. These promoters usually respond to chemical or physical stimuli such as temperature or light.

In a specific aspect of the invention, the inducible promoter is selected among rhizobium promoters that are:
activated by low oxygen conditions, like promoters directly or indirectly controlled by FixJ in S. meliloti, or
activated by nitric oxide, like promoters controlled by NnrR in S. meliloti, or
activated by stress conditions, like promoters controlled by RpoE2 in S. meliloti.

In a specific aspect of the invention, the plant of the Leguminosae family is selected among the group consisting of alfalfa; beans; broad bean; chickpea; clover; cowpea; lentil; lupine; pea; peanut; soybean, sweet clover and vetch.

In a specific embodiment of the invention, the associated bacterium of the rhizobium family is selected among the group consisting of Sinorhizobium meliloti, Rhizobium leguminosarum bv phaseoli, Rhizobium etli, Rhizobium leguminosarum bv viciae, Rhizobium leguminosarum bv trifolii, Bradyrhizobium japonicum, Mesorhizobium ciceri, Rhizobium lupini, Bradyrhizobium sp. (arachis).

In a preferred aspect of the invention, the plant of the Leguminosae family is the soybean Glycine max, and the bacterium of the rhizobium family is Bradyrhizobium japonicum.

In another preferred aspect of the invention, the plant is Medicago sativa (alfalfa) and the bacterium is Sinorhizobium meliloti.

The invention is also related to a method for delaying the senescence, and thus increasing the life-time of symbiotic nodules, comprising inoculating a plant of the Leguminosae family with a bacterium of the rhizobium family, wherein said rhizobium overexpresses a gene coding for a flavohemoglobin protein.

Symbiotic nodules have a limited life-time. The phrase “delaying nodule senescence” means that the rate of appearance of senescent nodules on plant roots with the symbiotic system of the invention is slower than with the wild type symbiotic system. In indeterminate nodules such as those formed by Medicago plants, the first sign of senescence is the appearance of a new zone proximal to the root, having a greenish color. Usually, for Medicago truncatula plants grown in laboratory conditions in the presence of wild type S. meliloti, 40 days after inoculation, about 50% of nodules present the first senescence zone. Several ultrastructural alterations in the nodule tissues are then observed, and eventually the cytosol of cells undergoes lysis.

Senescence process can also be induced by a stress, for example a ‘dark stress’ i.e. the exposure of plants having nodules to dark for a long period (about 72 hours for example). Surprisingly, the inventors demonstrated that the presence of NO induces this senescence process into nodules. The NO-detoxifying enzyme flavohemoglobin, when overexpressed in a rhizobium (hmp++-rhizobium), part of a nodule, delays the senescence process of the nodule by decreasing the NO level.

In a specific embodiment of the invention, 40 days after inoculation, less than 50% of hmp++-rhizobium-containing-nodules present said greenish zone of senescence. Preferentially, less than 30% of nodules present this senescence zone, more preferentially less than 20%, and even more preferentially less than 10% of the nodules of the population present this senescence zone. In another embodiment of the invention, nine weeks after inoculation, less than 50% of hmp++-rhizobium-containing-nodules present a zone of senescence. Preferentially, less than 30% of these nodules present a senescence zone, and more preferentially less than 20% of the nodules of the said population present this senescence zone.

According to a specific aspect of the method for delaying the senescence of nodules, the gene coding for a flavohemoglobin protein in the rhizobium is endogenous. Preferentially, a natural (non-genetically modified) rhizobium has been selected for its high expression of a gene encoding a flavohemoglobin protein. Such selection techniques are well known by the man skilled in the art, and are easily performed to isolate such rhizobium. The ‘high expression of a gene encoding a flavohemoglobin protein’ designates a level of expression at least superior of 20% to the level of expression usually observed in a regular rhizobium, preferentially at least 30% superior, and more preferentially 50% or 100% superior to the level of expression usually observed in a regular rhizobium.

The invention is also related to a method for cultivating a plant of the Leguminosae family, comprising inoculating the plant with a bacterium of the rhizobium family to allow the plant to develop nodules, wherein said rhizobium overexpresses a gene coding for a flavohemoglobin protein. In a particular aspect of the invention, the rhizobium overexpresses an endogenous gene coding for a flavohemoglobine.

Inoculation can be performed in different ways, either by treating seeds with the rhizobium strain, or by incorporating it in the soil. The rhizobium is either stuck (in powder form) to the seeds immediately before sawing, or mixed (in granular form) with seeds at the time of sawing. The rhizobium can also be sprayed (in liquid form) on the surface of the soil, or incorporated (in granular or liquid form) to the soil independently of, or just before sawing.

In a preferred aspect of the invention, the method comprises a step of harvest of either forage or seeds produced from the cultivated Leguminosae.

For both methods according to the invention, the plant of the Leguminosae family is preferentially selected among the group consisting of alfalfa; bean; broad bean; chickpea; clover; cowpea; lentil; lupine; pea; peanut; soybean and vetch.

The associated bacterium of the rhizobium family is selected among the group consisting of Sinorhizobium meliloti, Rhizobium leguminosarum bv phaseoli, Rhizobium etli, Rhizobium leguminosarum bv viciae, Rhizobium leguminosarum bv trifolii, Bradyrhizobium japonicum, Mesorhizobium ciceri, Rhizobium lupini, Bradyrhizobium sp. (arachis).

In a preferred aspect of the methods according to the invention, the plant of the Leguminosae family is the soybean Glycine max, and the bacterium of the rhizobium family is Bradyrhizobium japonicum.

In another preferred aspect of the invention, the plant is Medicago sativa (alfalfa) and the bacterium is Sinorhizobium meliloti.

### DRAWINGS

FIG. 1. Time-course (in days) of nodule senescence on Medicago truncatula roots inoculated with the wild-type (Wt) or the flavohemoglobin-overexpressing (hmp⁺⁺) Sinorhizobium meliloti strains.

FIG. 2. Time-course (in weeks) of nodule senescence on Medicago truncatula roots inoculated with the wild-type (Wt—black) or the flavohemoglobin-overexpressing (hmp⁺⁺—grey) Sinorhizobium meliloti strains.

FIG. 3. Time course of nitrogen fixation by Medicago truncatula roots inoculated with the wild-type (Wt—black) or the flavohemoglobin-overexpressing (hmp⁺⁺—grey) Sinorhizobium meliloti strains.

FIG. 4. Time course of shoot biomass production by Medicago truncatula inoculated with the wild-type (Wt—black) or the flavohemoglobin-overexpressing (hmp⁺⁺—grey) Sinorhizobium meliloti strains.

FIG. 5. Dark stress-induced nodule senescence on Medicago truncatula roots inoculated with the wild-type (Wt—black) or the flavohemoglobin-overexpressing (hmp⁺⁺—grey) Sinorhizobium meliloti strains.

### EXAMPLES

### Example 1

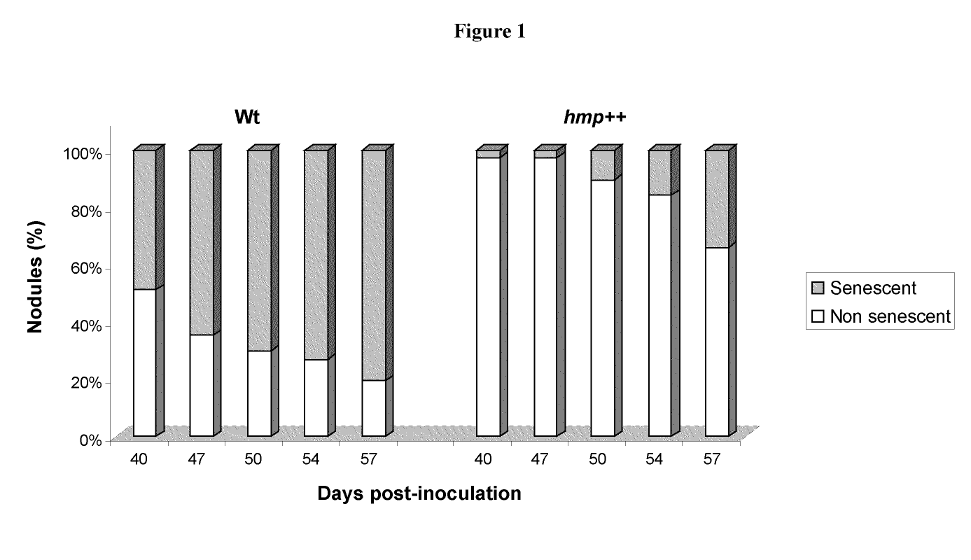

M. truncatula plantlets grown on nitrogen-free Farhaeus solid medium were inoculated with the wild type Rm2011 S. meliloti strain (Wt) or the strain overexpressing the flavohemoglobin gene (hmp⁺⁺) (Meilhoc et al. 2010). Evolution of nodule senescence was visually monitored: a nodule was judged senescent when presenting a greenish senescence zone in its proximal part. Observations made between 40 and 57 days post-inoculations (dpi) are reported as a percentage of the total number of nodules examined (81 and 41 nodules for the wt and hmp⁺⁺ strains, respectively). Results of a representative experiment are shown in FIG. 1. Forty days post-inoculation (dpi), while ˜50% of the nodules induced by the Wt strain displayed a senescence zone, very little sign of senescence was visible yet for the nodules induced by the hmp⁺⁺ strain. At 57 dpi, while 80% of the Wt-induced nodules were clearly senescent, only one third of the hmp⁺⁺-induced nodules displayed visible signs of senescence.

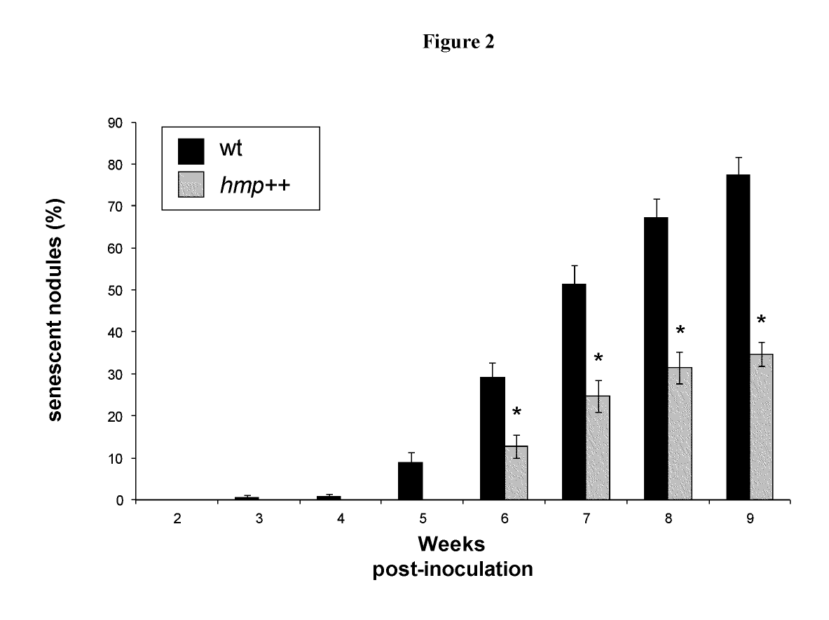

The same experiment was performed during a longer time; FIG. 2 shows the mean and standard error of results from two independent additional experiments (stars indicate results significantly different from the results obtained with the Wt strain, student t test, p<0.01). The results show that at nine weeks after inoculation, more than 70% of nodules induced by the Wt strain are senescent, although less than 40% of nodules induced by the hmp++ strain started the senescence process.

### Example 2

To quantify the impact of delaying nodule senescence on the plants, the shoot dry weight and nitrogenase activity of M. truncatula plants inoculated with either the Wt or the hmp⁺⁺ strains (using an acetylene reduction assay, ARA) were measured 46 days post-inoculation. The results of a representative experiment are shown in Table 1 (25 plants for the dry weight and 10 plants for the ARA test). Forty-six days post-inoculation, the shoot dry weight and nitrogenase activity of plants inoculated with the hmp⁺⁺ strain were higher than those of plants inoculated with the Wt strain.

At later stages of the cultures (i.e. 9 weeks post-inoculation), the aerial parts of the wt-inoculated plants were more chlorotic than those of the hmp⁺⁺-inoculated plants (approximately twice as much yellowish leaves).

TABLE 1
Shoot dry weight and nitrogenase activity of M. truncatula plants 46 days
after inoculation with either the wt or hmp⁺⁺ S. meliloti strains.

| | | Nitrogenase activity |
|---|---|---|
| | Shoot dry weight (mg) | (Arbitrary Units) |
| Wt | 17.9 (±2.5) | 5.5 (±0.9) |
| hmp⁺⁺ | 21.4 (±2.3)* | 8.3 (±1.4)* |

*significantly different from the Wt (student t test, p < 0.01)

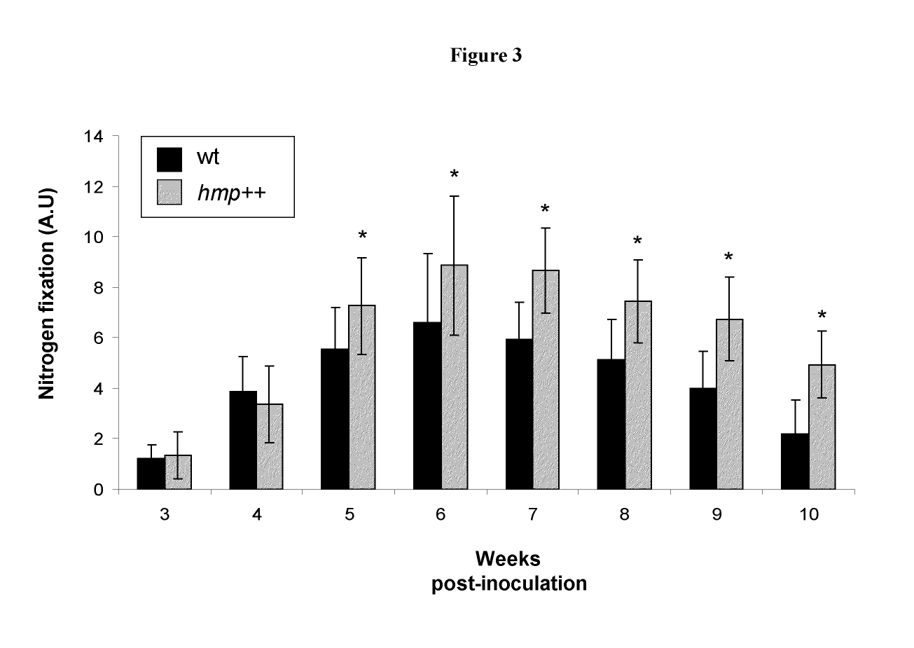

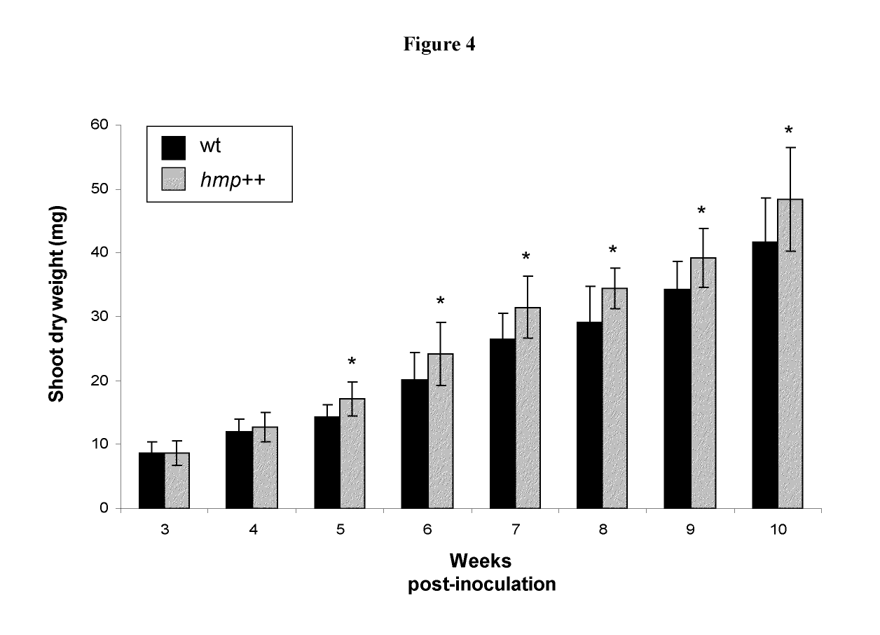

The same experiment was performed on a 10 weeks time-course. FIGS. 3 and 4 show the mean and standard deviation of results from two independent experiments (at least 20 plants for each); stars indicate results significantly different from the results obtained with the Wt strain (student t test, p<0.05).

Results on FIGS. 3 and 4 show that from five weeks post-inoculation, the hmp++-containing nodules show a significant increase in nitrogen fixation. In particular, ten weeks post-inoculation, the observed nitrogen-fixation is more than double in hmp++ strain-containing nodules than in Wt strain-containing nodules. Therefore, the overexpression of hmp gene in S. meliloti allows a better nitrogen fixation by the nodules.

Concomitantly, the same plants show an increased shoot dry weight, i.e. an increased biomass production. FIG. 4 shows that from five weeks post-inoculation, a significant increase of biomass is observed in hmp++ strain-inoculated plants, in comparison with the Wt strain-inoculated plants.

### Example 3

Three weeks post-inoculation, M. truncatula plants inoculated with S. meliloti, either the Wt or the hmp++ strain, are submitted to a dark stress for 72 hours (‘treated’), while negative controls are not (‘non treated’).

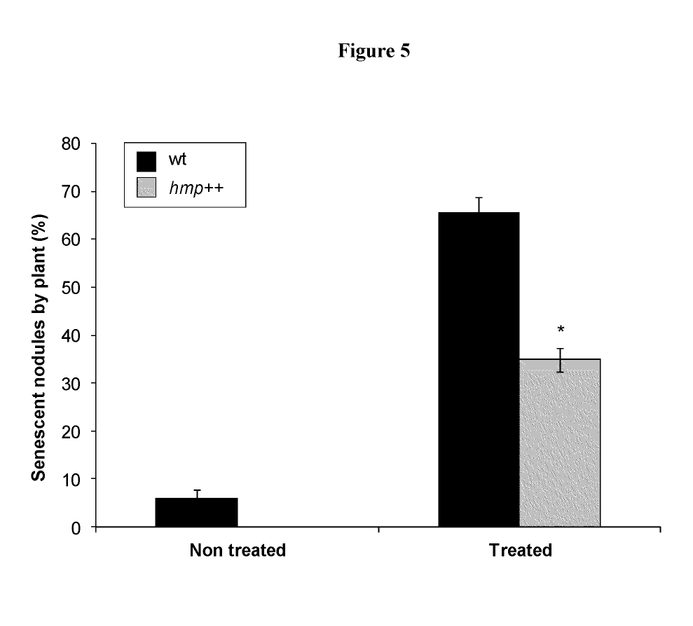

One week after the return of plants to normal conditions, the number of senescent nodules is measured. FIG. 5 shows the mean and standard error of results from three independent experiments (total of ˜30 plants for each point); stars indicate results significantly different from the results obtained with the Wt strain (student t test, p<0.01). As shown in FIG. 5, the fraction of senescent nodules by plant that appeared after the dark stress is about 65% for plants inoculated with a WT strain of rhizobium. On the contrary, plants inoculated with a hmp++ strain of rhizobium have been more resistant to the dark stress, showing only 35% senescent nodules per plant on average, and at the maximum 50% senescent nodules.

These results show that the over-expression of the gene hmp in S. meliloti allows the obtention of nodules having a delayed senescence, both under physiological conditions (‘natural senescence’) and under stress conditions inducing a non-natural senescence.

### REFERENCES

Dombrecht B, Vanderleyden J, Michiels J. (2001) Stable RK2-derived cloning vectors for the analysis of gene expression and gene function in gram-negative bacteria. Mol Plant Microbe Interact 14: 426-430.
Gardner, P. R. (2005). Nitric oxide dioxygenase function and mechanism of flavohemoglobin, hemoglobin, myoglobin and their associated reductases. J Inorg Biochem. 99, 247-266.
Kovach M E, Elzer P H, Hill D S, Robertson G T, Farris M A, Roop R M 2nd, Peterson K M. (1995) Four new derivatives of the broad-host-range cloning vector pBBR1MCS, carrying different antibiotic-resistance cassettes. Gene 166: 175-176
Mishina, T. E., Lamb, C., and Zeier, J. (2007). Expression of a nitric oxide degrading enzyme induces a senescence programme in Arabidopsis. Plant Cell Environ 30, 39-52.
Meilhoc E, Cam Y, Skapsi A, Bruand C. (2010) The response to nitric oxide of the nitrogen fixing symbiont Sinorhizobium meliloti. Mol Plant Microbe Interact. 23: 748-759.
Puppo A, Groten K, Bastian F, Carzaniga R, Soussi M, Lucas M M, de Felipe M R, Harrison J, Vanacker H, Foyer C H. (2005) Legume nodule senescence: roles for redox and hormone signalling in the orchestration of the natural aging process. New Phytol. 165:683-701.
Ramirez M, Valderrama B, Arredondo-Peter R, Soberón M, Mora J, Hernandez G. (1999) Rhizobium etli genetically engineered for the heterologous expression of Vitreoscilla sp. hemoglobin: effects on free-living and symbiosis. Mol Plant Microbe Interact. 12: 1008-1015.
Redondo F J, de la Pena T C, Morcillo C N, Lucas M M, Pueyo J J. (2009) Overexpression of flavodoxin in bacteroids induces changes in antioxidant metabolism leading to delayed senescence and starch accumulation in alfalfa root nodules. Plant Physiol. 149:1166-78.
Sancho, J. (2006). Flavodoxins: sequence, folding, binding, function and beyond. Cell Mol Life Sci 63, 855-864.

1. A symbiotic system comprising:
a plant of the Leguminosae family, and
a bacterium of the rhizobium family,
wherein in said bacterium a gene coding for a flavohemoglobin protein is overexpressed.

2. A symbiotic system of claim 1, wherein the gene is endogenous.

3. A symbiotic system of claim 1, wherein the gene is located on the rhizobium genome.

4. A symbiotic system of claim 1, wherein the gene is located on a plasmid.

5. A symbiotic system of claim 1, wherein the gene is under the control of a constitutively active promoter.

6. A symbiotic system of claim 1, wherein the gene is under the control of a promoter that is functional in specific zones of the nodule or at specific stages of the symbiosis.

7. A symbiotic system of claim 1, wherein the gene is under the control of an inducible promoter, selected from the promoters activated by:
low oxygen conditions,
nitric oxide, or
stress conditions.

8. A symbiotic system of claim 1, wherein the plant of the Leguminosae family is selected from the group consisting of alfalfa; beans; broad bean; chickpea; clover; cowpea; lentil; lupine; pea; peanut; soybean; sweet clover and vetch.

9. A symbiotic system of claim 1, wherein the associated bacterium of the rhizobium family is selected from the group consisting of Sinorhizobium meliloti, Rhizobium leguminosarum bv phaseoli, Rhizobium etli, Rhizobium leguminosarum bv viciae, Rhizobium leguminosarum bv trifolii, Bradyrhizobium japonicum, Mesorhizobium ciceri, Rhizobium lupini, and Bradyrhizobium sp. (arachis).

10. A symbiotic system of claim 1, wherein the plant of the Leguminosae family is the soybean Glycine max and the bacterium of the rhizobium family is Bradyrhizobium japonicum, or the plant is Medicago sativa and the bacterium is Sinorhizobium meliloti.

11. A method for delaying the senescence of symbiotic nodules, comprising inoculating a plant of the Leguminosae family with a bacterium of the rhizobium family, wherein said rhizobium overexpresses a gene coding for a flavohemoglobin protein.

12. The method of claim 11, wherein the senescence of symbiotic nodules is induced by a stress.

13. The method of claim 11, wherein the gene coding for a flavohemoglobin protein is endogenous.

14. A method for cultivating a plant of the Leguminosae family, comprising inoculating the plant with a bacterium of the rhizobium family to allow the plant to develop nodules, wherein said rhizobium overexpresses a gene coding for a flavohemoglobin protein.

15. The method of claim 14 wherein the gene coding for a flavohemoglobin protein is endogenous.

16. The method of claim 11, wherein the plant of the Leguminosae family is the soybean Glycine max and the bacterium of the rhizobium family is Bradyrhizobium japonicum, or the plant is Medicago sativa and the bacterium is Sinorhizobium meliloti.

17. The method of claim 14, wherein the plant of the Leguminosae family is the soybean Glycine max and the bacterium of the rhizobium family is Bradyrhizobium japonicum, or the plant is Medicago sativa and the bacterium is Sinorhizobium meliloti.
